(19) United States
(12) Patent Application Publication
(10) Pub. No.: US 2014/0016234 A1
(43) Pub. Date: Jan. 16, 2014

(54) HARDENED LAYER ON A DRIVE HEAD

(71) Applicant: Darin D. Lindig, Boise, ID (US)

(72) Inventor: Darin D. Lindig, Boise, ID (US)

(21) Appl. No.: 13/548,780

(22) Filed: Jul. 13, 2012

(51) Int. Cl. G11B 5/39; G11B 5/127

(52) U.S. Cl. 360/313; 29/603.04; G9B/5.113

(57) ABSTRACT

A method of forming a hardened layer on a tape drive head assembly comprising building a tape drive head assembly, in which a number of layers of amorphous material are applied along read and write components of the tape drive head assembly as the tape drive head assembly is built and selectively heating portions of the amorphous material. A drive head assembly comprising a write component, a magnetic resistive element, and a number of layers of amorphous material, in which a portion of the amorphous material is hardened.

### BACKGROUND

Tape drive heads are a form of transducer used to convert electrical signals to magnetic fluctuations or magnetic fluctuations to electrical signals. In either case, a magnetic tape, when directed across the head, is written to or read from using the creation of a magnetic flux or the detection of a varying magnetic field respectively. When a tape drive is used often, the tape used in the drive may cause the head to malfunction. Specifically, the constant or continual processing of the magnetic tape over the head may cause stain build-ups on the head or the drive head itself to deteriorate or wear down the head.

### BRIEF DESCRIPTION OF THE DRAWINGS

The accompanying drawings illustrate various examples of the principles described herein and are a part of the specification. The examples do not limit the scope of the claims.

FIG. 1 is a top view diagram of a tape drive head assembly according to one example of the principles described herein.

FIG. 2 is a cross-sectional diagram of a tape drive head assembly along line 115 of FIG. 1 according to one example of principles described herein.

FIG. 3 is a cross-sectional diagram of a tape drive head assembly along circle 220 of FIG. 2 according to one example of principles described herein.

FIG. 4 is a cross-sectional diagram of a tape drive head assembly along circle 220 of FIG. 2 according to another example of principles described herein.

FIG. 5 is a flowchart showing a method of forming a hardened oxide glass layer on a tape drive head assembly according to one example of principles described herein.

FIG. 6 is a flowchart showing another method of forming a hardened oxide glass layer on a tape drive head assembly according to one example of principles described herein.

Throughout the drawings, identical reference numbers designate similar, but not necessarily identical, elements.

### DETAILED DESCRIPTION

As briefly discussed above, a tape drive head may be subjected to continual contact and abrasion from magnetic tape. As such, the head may become dirty or be subjected to an amount of abrasion over time.

One way to solve this would be to adjust the distance between the head and the tape. However, adjusting of the head relative to the magnetic tape may cause unintended consequences. Specifically, when the tape is brought too close to the head, the tape may cause stains to form on the head. The magnetic tape, aside form including magnetic materials that store data, also may include other chemicals used to spread the magnetic material over the tape or lubricate the tape during use. As a length of tape move across the head, these chemicals may rub off of the head and cause a thin film to form on the head. The stains formed as a result may reduce the ability of the head to read from or write to the magnetic tape because the distance between the head and the tape has been increased. Similarly, moving the tape away from the head in order to prevent this build-up of material may prevent the data to be read from or written to the tape properly. The magnetic force created by the elements in the head may be relatively weak and by increasing the distance the effectiveness of the head may be reduced.

The formulation of the tape can be changed as well to prevent the stain build-up from occurring. However, as the abrasiveness of the formulation increases, the more the head is adversely affected. Specifically, as the abrasiveness of the formulation increases to offset the build-up of the film, the tape itself may rub away at the head and cause a gap to form between the tape and the head. This may in turn increase the distance form the elements within the head and the tape and lessen the effectiveness of the head to read or write.

Another alternative would be to make the elements within the head out of a stronger material. However, simply changing the material would not necessarily work as some of the elements within the head are to produce a magnetic flux; a characteristic which some materials do not possess.

Still further, on alternative to increasing the usable life of the head would be to reduce the gap between the supporting ceramic materials that hold the read and write elements within the head. However, here the ability to decrease the gap is limited to the physical size of the elements.

The present application, therefore, describes a method of forming a hardened layer on a tape drive head assembly comprising building a tape drive head assembly in which a number of layers of amorphous material are applied along read and write components of the tape drive head assembly as the tape drive head assembly is built and selectively heating portions of the amorphous material. The present application further describes a drive head assembly comprising a write component, a magnetic resistive element, and a number of layers of amorphous material, in which a portion of the amorphous material is hardened.

In the following description, for purposes of explanation, numerous specific details are set forth in order to provide a thorough understanding of the present systems and methods. It will be apparent, however, to one skilled in the art that the present apparatus, systems and methods may be practiced without these specific details. Reference in the specification to “an example” or similar language indicates that a particular feature, structure, or characteristic described in connection with that example is included as described, but may not be included in other examples.

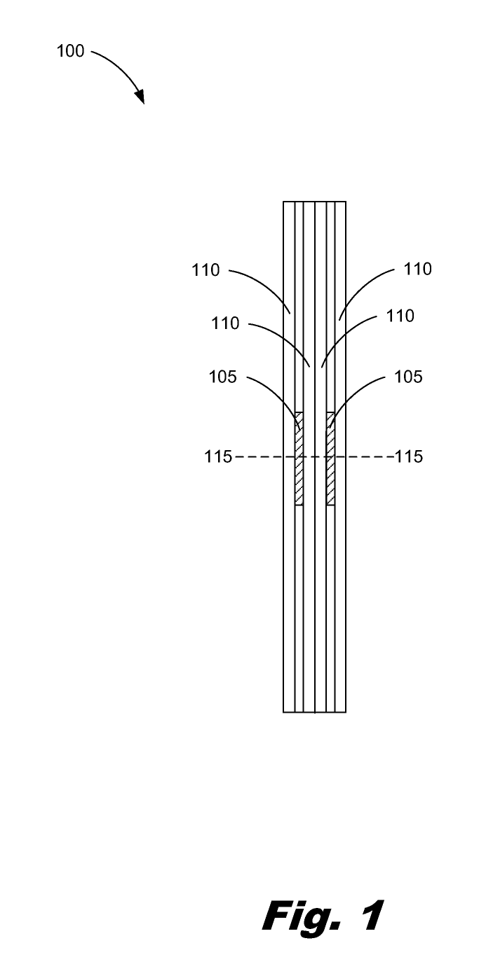

FIG. 1 is a top view diagram of a tape drive head assembly (100) according to one example of the principles described herein. The tape drive head assembly (100) may comprise an active part (105) which may include a number of elements including those elements in a tape drive head used to record and read information from the magnetic tape. The tape drive head assembly (100) may be manufactured in a process similar to that of manufacturing an integrated circuit (IC) providing electromagnetic elements.

The tape drive head assembly (100) may also comprise a number of structural support layers (110) used to encase the active part (105) of the tape drive head assembly (100). In one example, the structural support layers (110) may be made of cermet. Cermet is composite material composed of ceramic and metallic materials. In this example, the cermet may be designed to have a high resistance to high temperatures, a relatively high hardness.

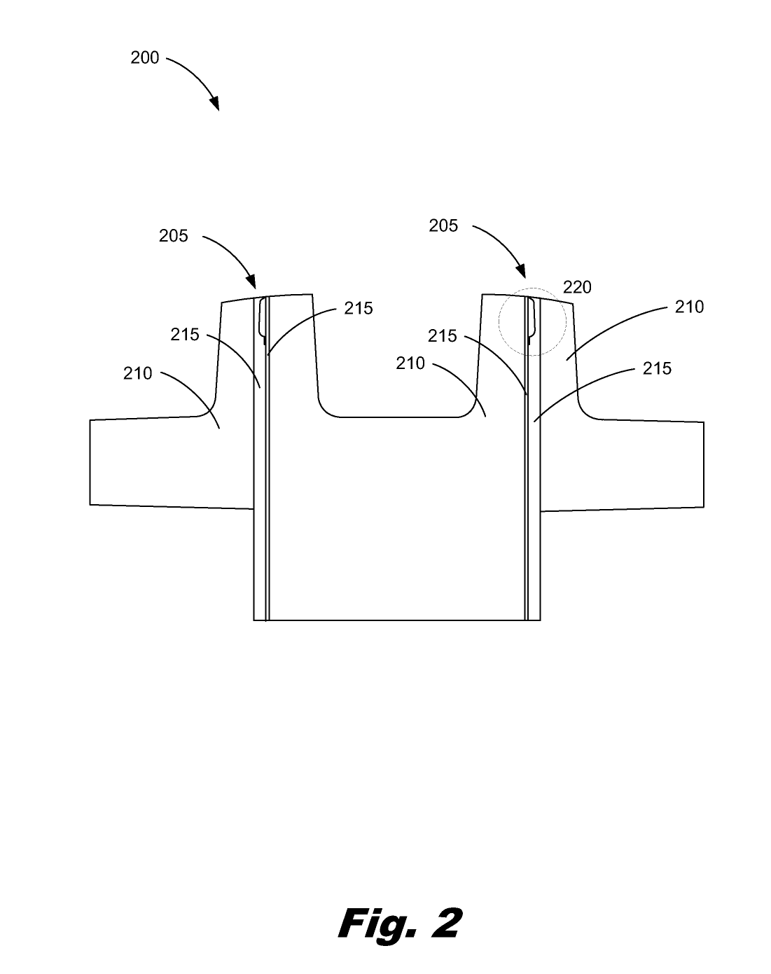

FIG. 1 also has a line (115) bisecting the tape drive head assembly (100). If the tape drive head assembly (100) were to be cut along this line, the view from the side could be seen in FIG. 2. FIG. 2, therefore, is a cross-sectional diagram of a tape drive head assembly (200) along line (115) of FIG. 1 according to one example of principles described herein. In the example shown in FIG. 2, the tape drive head assembly (200) includes two reading/writing heads (205). The two heads may work together when the magnetic tape is brought across the top of the heads (205). Specifically, as one head writes to the magnetic tape, the other head confirms that the magnetic tape has been written to by reading the magnetic tape. As such, in one example, both heads (205) may comprise two sets of ferromagnetic material; one used to read the data stored on the magnetic tape and the other to write to the magnetic tape.

The heads (205) may be encased in a number of layers of material to both support and protect the heads (205). In one example, a layer of cermet (210) may be used as a support structure for the rest of the head (205). As discussed above, this cermet layer may comprise a ceramic and metallic materials which, when combined, produce a material that is both resistive to heat as well as hard. The layer of cermet (210) encases the rest of the components such as layers of an oxide (i.e., Al₂0₃) material (215), nickel/iron head components, and other materials. In one example, the layers of an oxide (i.e., Al₂0₃) material may be amorphous in it s crystalline structure and may be applied in layers to the head (205) using a sputtering technique.

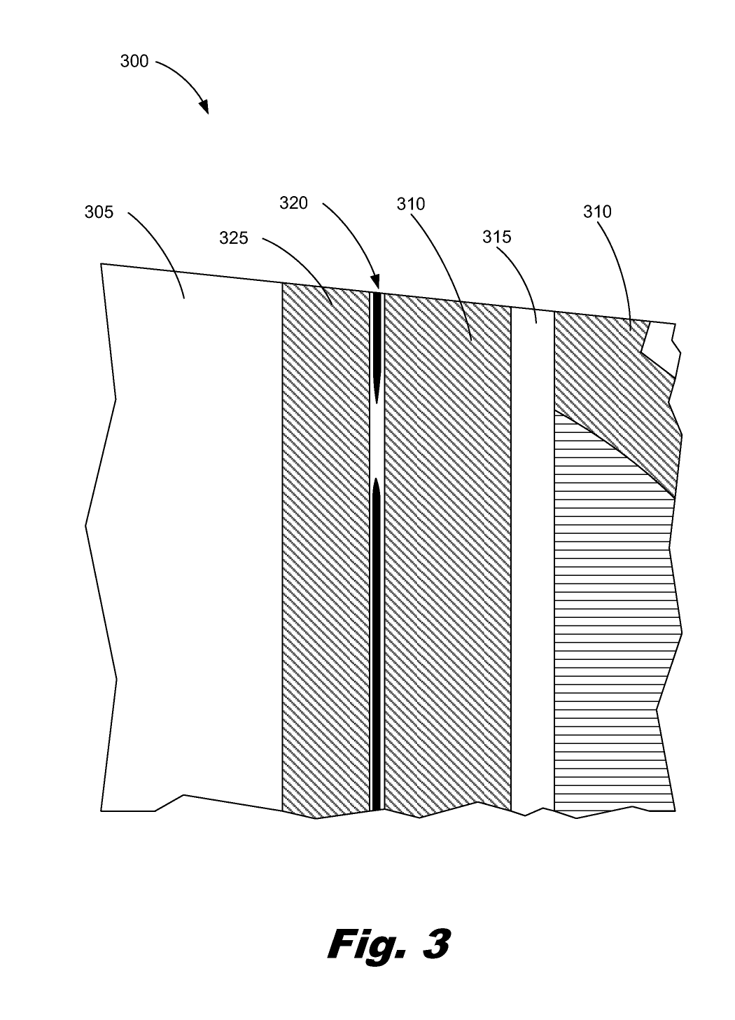

FIG. 2 also comprises a circle (220) encircling an upper part of the one of the heads (205). FIG. 3 shows a cross-sectional diagram of a tape drive head assembly (300) within circle 220 of FIG. 2 according to one example of principles described herein. The close up view of the tape head (300) again shows the layers of oxide (i.e. Al₂0₃) material (305) as well as the nickel/iron components of the head (300). The head (300) comprises a write component (310) with a gap (315) defined in the component (310) such that a magnetic flux may be produced between the gap. The produced magnetic flux may be used to write information to the magnetic tape.

The gap (315) may be filled with an amorphous (i.e. Al₂0₃) material (305) but, as will be described in more detail below, may be selectively heated such that a top layer forms a harder layer of material. In one example, the material may be an oxide material and may be selectively heated to form an alpha phase crystalline layer of oxide glass. The thickness of the alpha phase crystalline layer of oxide glass may be varied, however, in one example the thickness may be around 50 nm. The amorphous material (305) may comprise, but is not limited to, aluminum oxide (Al₂0₃ including α-Al₂0₃, β-Al₂0₃, and γ-Al₂0₃), a silicon oxide (SiO₂ or SiO), a titanium oxide (TiO₂; TiO; Ti₂O₃; Ti₃O; Ti₂O; δ-TiOₓ (x=0.68-0.75); or TiₙO₂ₙ₋₁ where n=3-9 inclusive)), iron oxide (FeO; Fe₃O₄; and oxides of Fe₂O₃ including α-Fe₂O₃; β-Fe₂O₃; δ-Fe₂O₃; and ε-Fe₂O₃), silicon nitrides (Si₃N₄ including α-Si₃N₄, β-Si₃N₄, and γ-Si₃N₄; S₂iN₃; SiN; Si₂N), or combinations thereof.

The head (300) may further comprise a magnetic resistive element (320) along side the write component (310) and sandwiched in between the write component (310) and another layer of nickel/iron (325). In one example, the magnetic resistive element (320) may be encased within a layer of oxide (Al₂0₃) material as well, further supporting the magnetic resistive element (320).

Although FIGS. 1, 2, and 3 show a specific layout of a tape drive head assembly (100, 200, 300), the tape drive head assembly (100, 200, 300) may be arranged differently to fit different circumstances as well. Therefore, for example, although FIG. 2, shows that the head assembly (200) comprises two heads (205), more or less heads (205) may be incorporated into the head. Additionally, although FIGS. 1, 2, and 3 shows each write component (310) is matched up with a magnetic resistive element (320), any number and combinations of these elements may be used. Therefore, the tape drive head assembly (100, 200, 300) is merely an example used in the present description as such.

In operation, the tape head assembly (100, 200, 300) has a length of magnetic tape passed over it. As the magnetic tape passes over the tape head assembly (100, 200, 300), the magnetic resistive elements (320) may sense an electrical resistance change. . This change is then used to produce a signal. Similarly, when the magnetic tape passes over the tape head assembly (100, 200, 300), the write component (310) may create a magnetic flux such that the magnetic particles within the magnetic strip align in such as was so as to represent data that may be retrieved later by the magnetic resistive elements (320).

However, as the amount of magnetic tape that passes over the tape head assembly (100, 200, 300) increases, the damage to the tape head assembly (100, 200, 300) also increases. In on example, this damage can be produced in the form of a film that is laid over the tape head assembly (100, 200, 300) originating from the magnetic tape. In another example, the damage is produced as a result of the abrasiveness of the magnetic tape itself in which the magnetic tape rubs off layers of the tape head assembly (100, 200, 300). This causes parts of the magnetic resistive elements (320) and write components (310) to be damaged and loose the ability to write and read to and from the magnetic tape. As mentioned above, however, the present description provides for an oxide (Al₂0₃) material that is selectively heated such that the hardness of the oxide (Al₂0₃) material prevents those components from being damaged.

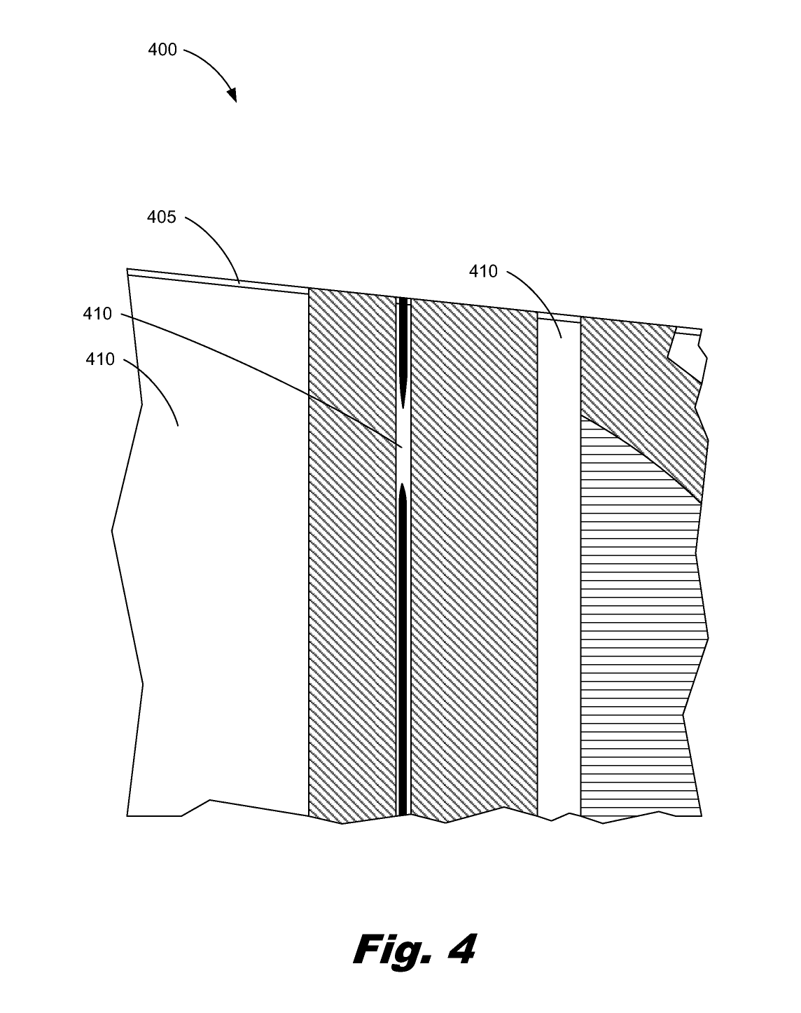

Turning now to FIG. 4, a cross-sectional diagram of a tape drive head assembly (400) along circle 220 of FIG. 2 according to another example of principles described herein is shown. The tape drive assembly (400) may include similar components as that shown in FIG. 3. However, the tape head drive assembly of FIG. 4 may further include a hardened layer of oxide glass (405) on the top or uppermost part of the oxide layers (410). In FIG. 4, the top layer of oxide glass (405) was selectively hardened to create a stronger alpha phase oxide layer. In one example, the hardened layer of oxide glass (405) may have been selectively heated using a laser.

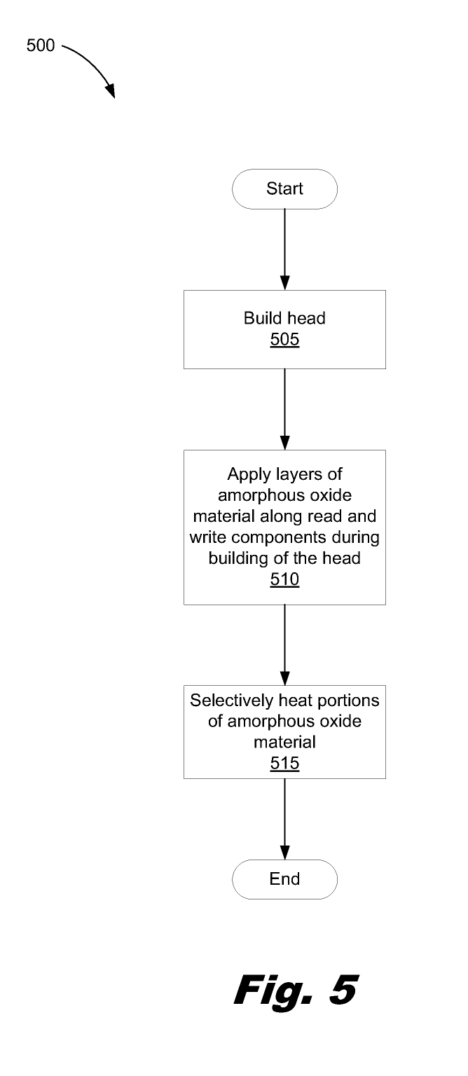

FIG. 5 is a flowchart showing a method (500) of creating a hardened oxide glass layer on a tape drive head according to one example of principles described herein. The method (500) may begin by building (505) the tape drive head assembly (100, 200, 300, 400). The tape drive head assembly (100, 200, 300, 400) may be built up using the systems and methods similar to those used to create silicon chips.

During the process a number of layers of amorphous oxide material (215, 305, 410) may be added in between the various layers within the tape drive head assembly (100, 200, 300, 400) as discussed above. In one example, the various layers of amorphous oxide material (215, 305, 410) may be applied in layers to the tape drive head assembly (100, 200, 300, 400) using a sputtering technique. In this example, a target comprising an amorphous oxide material (215, 305, 410) may be shot at with energetic particles such that individual atoms are ejected from the target and fall onto specific locations on the tape drive head assembly (100, 200, 300, 400).

In another example, a number of amorphous oxide material (215, 305, 410) layers may be applied around the read and write elements of the tape drive head assembly (100, 200, 300, 400). Specifically a number of amorphous oxide material (215, 305, 410) layers may be applied around the magnetic resistive element (320) and write components (310) of the tape drive head assembly (100, 200, 300, 400). Other layers of amorphous oxide material (215, 305, 410) may be applied around other components of the tape drive head assembly (100, 200, 300, 400) as well.

After the tape drive head assembly (100, 200, 300, 400) has been built (505) with the various layers of amorphous oxide material (215, 305, 410) being applied, a portion of each of the layers of amorphous oxide material (215, 305, 410) is selectively heated (515). The heating process (515) may heat a portion of the layer of the amorphous oxide material (215, 305, 410) leaving the rest of the elements within the tape drive head assembly (100, 200, 300, 400) cool. Indeed, selective heating of the portion of the amorphous oxide material (215, 305, 410) prevents destruction of the other elements within the tape drive head assembly (100, 200, 300, 400) that are more susceptible to heat. In one example, the amorphous oxide material (215, 305, 410) may be heated (515) using a laser. In this example, the wavelength, intensity and duration of the application of laser light may be varied to fit the particular amorphous oxide material (215, 305, 410) used as well as the intended hardness of the amorphous oxide material (215, 305, 410) that will result. The portion of the layer of amorphous material (215, 305, 410) that is selectively heated may include the portion that will come in direct contact with the magnetic tape during operation of the tape drive head assembly (100, 200, 300, 400). Indeed, looking at FIG. 3, the portions of the layers of amorphous material (215, 305, 315, 410) that come in contact with the magnetic tape are located at the top of the figure. FIG. 4, shows this layer (405) after being selectively heated.

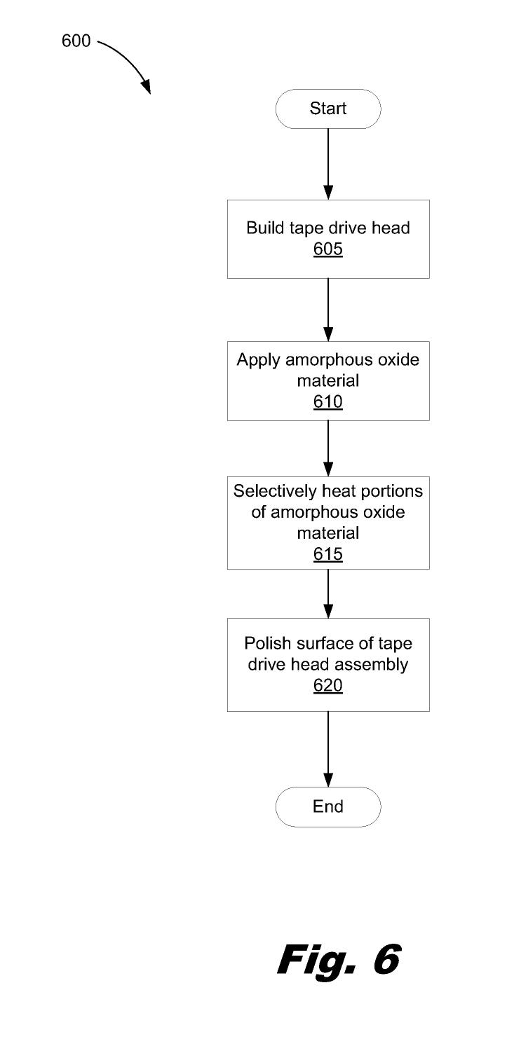

FIG. 6 is a flowchart showing another method of creating a hardened oxide glass layer on a tape drive head assembly according to one example of principles described herein. The method here may also begin with the tape drive head assembly (100, 200, 300, 400) being built (605) with the various layers of amorphous oxide material (215, 305, 410) being applied (610) as described above. A portion of the amorphous oxide material (215, 305, 410) may be selectively heated (615) such that the top portion is heated and not the rest of the components of the tape drive head assembly (100, 200, 300, 400). Because the rest of the components of the tape drive head assembly (100, 200, 300, 400) may be made of metals such as iron or nickel, the temperatures used to convert an amorphous oxide material (215, 305, 410) into a hardened alpha phase oxide material, for example, would melt or otherwise destroy those components. Selectively heating (615) those portions of the tape drive head assembly (100, 200, 300, 400) with, for example, a laser prevents the destruction of those components.

After the portions of the amorphous oxide material (215, 305, 410) are selectively heated (615), the surface of the tape drive head assembly (100, 200, 300, 400) may be polished (620). Polishing of the tape drive head assembly (100, 200, 300, 400) may help to smooth out the hardened layer of oxide material that was selectively heated (615). This may prevent particles of the magnetic tape from coagulating on the tape drive head assembly (100, 200, 300, 400) during use thereby preventing the stain buildup mentioned earlier.

As can be seen in FIGS. 3 and 4, the hardened layer of oxide material (405) acts as a harder barrier against the magnetic tape as it passes over the tape drive head assembly (100, 200, 300, 400). The write component (310) and magnetic resistive element (320) in particular are bordered by an upright layer of oxide material in which the surface of the oxide material that contacts the magnetic tape has been hardened (405). The hardening of the amorphous oxide material (215, 305, 410) to form the hardened layer (405) prevents that tape from rubbing on the write component (310) and magnetic resistive element (320) and in turn prevents those elements and others from wearing away during the useful lifetime of the tape drive head assembly (100, 200, 300, 400).

The specification and figures describe a tape drive head assembly (100, 200, 300, 400) and a method of forming a hardened layer (405) on a tape drive head assembly (100, 200, 300, 400). A hardened layer (405) of an amorphous material may be developed on the uppermost surface of the tape drive head. This hardened layer (405) may have a number of advantages, including preventing the components of the tape drive head from being degraded as the magnetic tape is passed across its surface. The layer of amorphous oxide material (215, 305, 410) may be hardened by selectively heating an uppermost portion of the amorphous oxide material (215, 305, 410) with a laser. The selective application of the electromagnetic energy from the laser may heat that uppermost portions of the layers of amorphous oxide material (215, 305, 410) while leaving the rest of the components of the tape drive head assembly (100, 200, 300, 400) relatively cool. This prevents the other components of the tape drive head assembly (100, 200, 300, 400) from melting or otherwise becoming degraded as a result.

The preceding description has been presented to illustrate and describe examples of the principles described. This description is not intended to be exhaustive or to limit these principles to any precise form disclosed. Many modifications and variations are possible in light of the above teaching.

What is claimed is:

1. A method of forming a hardened layer on a tape drive head assembly comprising:
building a tape drive head assembly, in which a number of layers of amorphous material are applied along read and write components of the tape drive head assembly as the tape drive head assembly is built; and
selectively heating portions of the amorphous material.

2. The method of claim 1, in which the number of layers of amorphous material comprise an aluminum oxide, a silicon oxide, a titanium oxide, an iron oxide, silicon nitride, or combinations thereof.

3. The method of claim 1, in which selectively heating portions of the amorphous material is done via a laser.

4. The method of claim 3, in which selectively heating portions of the amorphous material causes a transformation to a harder material.

5. The method of claim 4, in which change in the crystalline phase of the amorphous material is a solid state phase transition in the amorphous material to the a-phase of the material.

6. The method of claim 5, further comprising polishing the layer of α-phase material.

7. A drive head assembly comprising:
a write component;
a magnetic resistive element;
and a number of layers of amorphous material;
in which a portion of the amorphous material is hardened.

8. The drive head assembly of claim 1, in which the number of layers of amorphous material comprise an aluminum oxide, a silicon oxide, a titanium oxide, an iron oxide, silicon nitride, or combinations thereof.

9. The drive head assembly of claim 1, in which the amorphous material is hardened by applying an amount of electromagnetic radiation on at least a portion of the layers of amorphous material.

10. The drive head assembly of claim 9, in which application of electromagnetic radiation on at least a portion of the layers of amorphous material causes a transformation to a harder material.

11. The drive head assembly of claim 10, in which the change in the crystalline phase of the amorphous material is a solid state phase transition in the amorphous material to the α-phase of the material.

12. A method of forming a tape drive head assembly comprising:
building a tape drive head assembly, in which a number of layers of amorphous oxide material are applied along read and write components of the tape drive head assembly as the tape drive head assembly is built;
selectively heating portions of the amorphous oxide material to form an α-phase of the oxide material; and
polishing the layer of α-phase material.

13. The method of claim 12, in which the number of layers of amorphous oxide material comprises an aluminum oxide, a silicon oxide, a titanium oxide, an iron oxide, or combinations thereof.

14. The method of claim 12, in which selectively heating portions of the amorphous oxide material is done via a laser.

15. The method of claim 12, in which the drive head assembly comprises a write component and a magnetic resistive element in which a portion of the write component and a magnetic resistive element are encased within the α-phase material.
